(19) United States
(12) Patent Application Publication
(10) Pub. No.: US 2012/0170796 A1
(43) Pub. Date: Jul. 5, 2012

(54) ULTRA-THIN LOUDSPEAKER STRUCTURE

(76) Inventors: Cheng-Hsiung Chen, Banqiao City (TW); Hsiang-Chih Yu, Zhonghe City (TW); Chu-You Hsieh, Xizhi City (TW); Chin-Chou Yang, Danshui Township (TW)

(21) Appl. No.: 12/983,328

(22) Filed: Jan. 3, 2011

(51) Int. Cl. H04R 1/00

(52) U.S. Cl. 381/424

(57) ABSTRACT

An ultra-thin loudspeaker structure mainly includes an upper drum paper, a lower drum paper and a steel sheet. A winding semicircle-shaped protrusion is disposed in a position adjacent to an edge of the lower drum paper, and thus a frame-defining portion is formed. The lower drum paper is provided with an opening at the center. The upper drum paper has an area approximately equal to that of an inner edge of the frame-defining portion. The upper drum paper is provided with an opening at the center. The steel sheet is provided with a sound-making member stacked by a plurality of ceramic material layers. A lead wire is welded to the sound-making member. The steel sheet is sandwiched between the upper drum paper and the lower drum paper. The upper drum paper is embedded in the inner edge of the frame-defining portion of the lower drum paper, and thus a thin loudspeaker is formed. After the sound-making member receives an audio signal, a sound is guided out through the upper drum paper and the lower drum paper. Therefore, the loudspeaker structure is applied to thinned products such as i-pad, i-phone or mobile phones, headphones, speaker boxes and notebook computers.

### BACKGROUND OF THE INVENTION

(a) Technical Field of the Invention

The present invention relates to an ultra-thin loudspeaker structure, and more particularly to an ultra-thin loudspeaker structure in which a sound is guided out through an upper drum paper and a lower drum paper after a sound-making member receives an audio signal, which thus is applied to thinned products such as i-pad, i-phone or mobile phones, headphones, speaker boxes and notebook computers, and which is convenient to fabricate and assemble.

(b) Description of the Prior Art

With the rapid progress of science and technology, common 3C products such as i-pad, i-phone or mobile phones, headphones, speaker boxes and notebook computers have been developed to be thinner and smaller. Correspondingly, components used in these 3C products become thinner. With regard to loudspeakers for making sounds, conventional loudspeakers can be miniaturized, but can not become thinner and lighter, thus saving power and consumptions. As a result, the conventional loudspeakers cannot meet requirements of the products. Furthermore, as for a miniaturized loudspeaker, a reproduction of high, medium and low audio frequencies needs to be considered, so that it is really unacceptable for a dealer and a consumer that the loudspeaker gets a thinned configuration at the expense of its audio frequency effects. In view of the above, the applicant of the present invention has made improvements to make thin loudspeakers convenient to fabricate and assemble and produce better sound effects after years of experience and continuous research and experiments in this field.

### SUMMARY OF THE INVENTION

A main object of the present invention is to provide an ultra-thin loudspeaker structure, in which a sound is guided out through an upper drum paper and a lower drum paper after a sound-making member receives an audio signal, which thus is applied to thinned products such as i-pad, i-phone or mobile phones, headphones, speaker boxes and notebook computers, and which is convenient to fabricate and assemble and produce better sound effects.

The ultra-thin loudspeaker structure includes an upper drum paper, a lower drum paper and a steel sheet. The lower drum paper is disposed in a position adjacent to an edge and is provided with a winding semicircle-shaped protrusion to form a frame-defining portion. The lower drum paper is provided with an opening at the center. The upper drum paper has an area approximately equal to that of an inner edge of the frame-defining portion. The upper drum paper is provided with an opening at the center. The steel sheet is provided with a sound-making member stacked by a plurality of ceramic material layers. A lead wire is welded to the sound-making member. The steel sheet is sandwiched between the upper drum paper and the lower drum paper. The upper drum paper is embedded in the inner edge of the frame-defining portion of the lower drum paper, and thus a thin loudspeaker is formed. After the sound-making member receives an audio signal, a sound is guided out through the upper drum paper and the lower drum paper. Therefore, the loudspeaker structure is applied to thinned products such as i-pad, i-phone or mobile phones, headphones, speaker boxes and notebook computers.

In the above ultra-thin loudspeaker structure, the upper drum paper and the lower drum paper are made of base paper, cloth, wood chip or foam, polyethylene terephthalate (PET), polyethylene naphthalate (PEN), polyetherimide (PEI), etc.

### BRIEF DESCRIPTION OF THE DRAWINGS

FIG. 1 is a three-dimensional view of the present invention.

FIGS. 2 and 3 are three-dimensional exploded views of the present invention.

FIG. 4 is a sectional view of the present invention.

FIG. 5 is a partially enlarged sectional view of the present invention.

FIG. 6 is a view of an embodiment of the present invention.

### DETAILED DESCRIPTION OF THE PREFERRED EMBODIMENTS

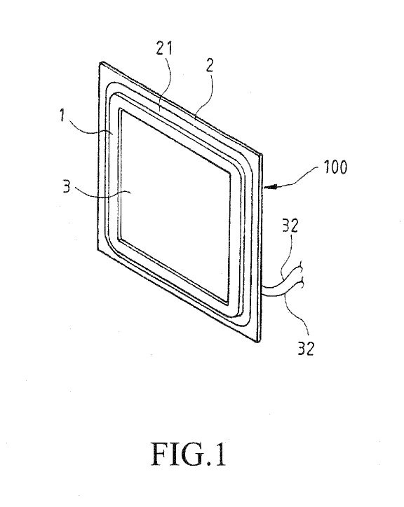

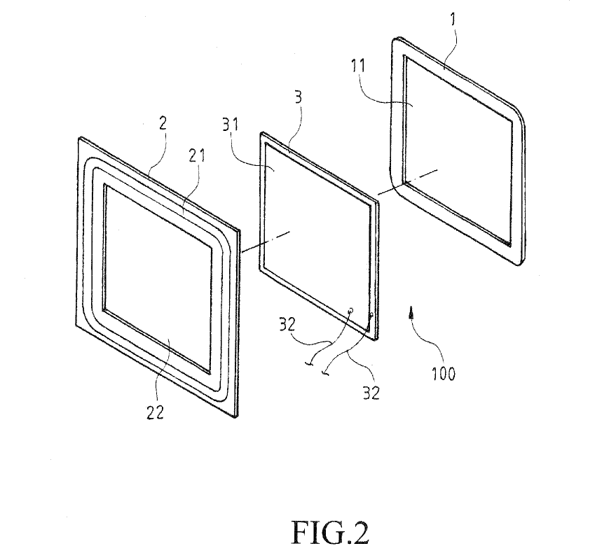

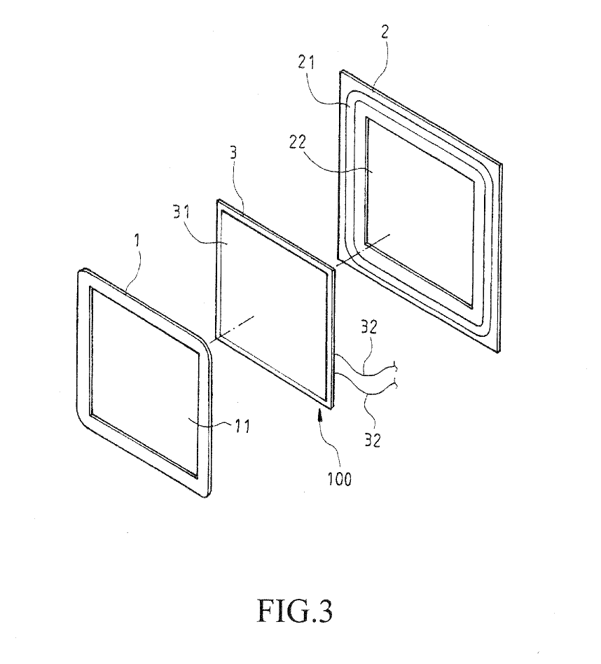

FIG. 1, FIG. 2 and FIG. 3 are respectively a three-dimensional view, two three-dimensional exploded views of the present invention. Referring to FIG. 1, FIG. 2 and FIG. 3, the present invention mainly includes an upper drum paper 1, a lower drum paper 2 and a steel sheet 3. In this embodiment, the lower drum paper 2 is made of base paper, cloth, wood chip or foam, polyethylene terephthalate (PET), polyethylene naphthalate (PEN), polyetherimide (PEI), etc. The lower drum paper 2 is designed to be square or circular. A winding semicircle-shaped protrusion is disposed in a position adjacent to an edge of the lower drum paper 2, and thus a protruding frame-defining portion 21 is formed. The lower drum paper 2 is provided with an opening 22 at the center (provided with a square opening 22 in this embodiment).

The upper drum paper 1 is made of base paper, cloth, wood chip or foam, polyethylene terephthalate (PET), polyethylene naphthalate (PEN), polyetherimide (PEI), etc. The upper drum paper 1 has an area approximately equal to that of an inner edge of the frame-defining portion 21 of the lower drum paper 2, and is provided with an opening 11 at the center (provided with a square opening 22 in this embodiment).

The steel sheet 3 is provided with a sound-making member 31 stacked by a plurality of ceramic material layers. A lead wire 32 is welded to the sound-making member.

With a combination of the aforementioned members, the steel sheet 3 is sandwiched between the upper drum paper 1 and the lower drum paper 2, and the upper drum paper 1 is embedded in the inner edge of the frame-defining portion 21 of the lower drum paper 2, and thus a thin loudspeaker 100 is formed. The lead wire 32 is connected to post-stage amplification circuits of different products. After the sound-making member 31 receives an audio signal, a sound is guided out through the upper drum paper 1 and the lower drum paper 2. Therefore, the loudspeaker structure is applied to thinned products such as i-pad, i-phone or mobile phones, headphones, speaker boxes and notebook computers.

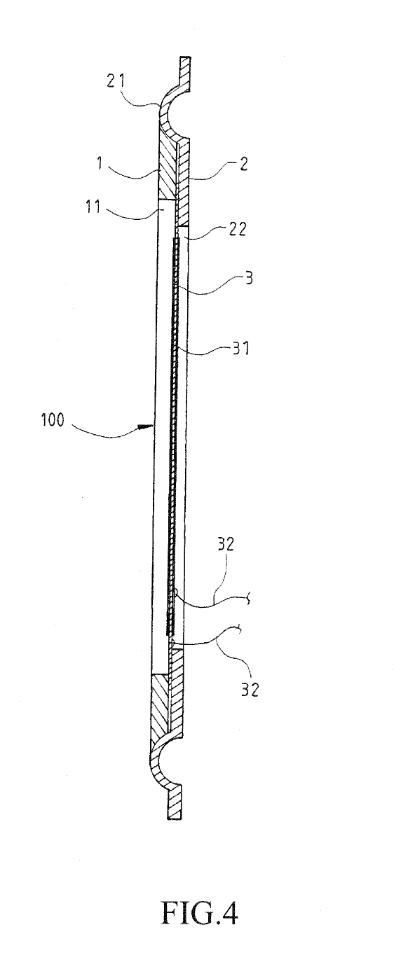

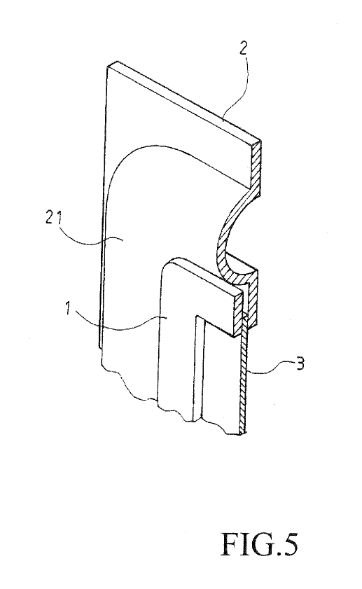

FIG. 4 and FIG. 5 are respectively a sectional view and a partially enlarged sectional view of the present invention. Referring to FIG. 4 and FIG. 5, during assembly, the steel sheet 3 of the present invention is sandwiched between the upper drum paper 1 and the lower drum paper 2. Since the frame-defining portion 21 is disposed in a position adjacent to an edge of the lower drum paper 2, a recess shape is formed at the center of the lower drum paper 2, and thus the upper drum paper 1 is embedded in the inner edge of the frame-defining portion 21 of the lower drum paper 2. The upper drum paper 1 and the lower drum paper 2 are adhered together with an adhesive, and thus a thin loudspeaker 100 is formed. After the sound-making member 31 disposed in the steel sheet 3 receives an audio signal, a sound is guided out through the upper drum paper 1 and the lower drum paper 2, without causing any audio frequency dissipation. The frame-defining portion 21 disposed in a position adjacent to an edge of the lower drum paper 2 can form pellet effects of common loudspeakers, and thus the thin loudspeaker 100 can achieve better sound effects.

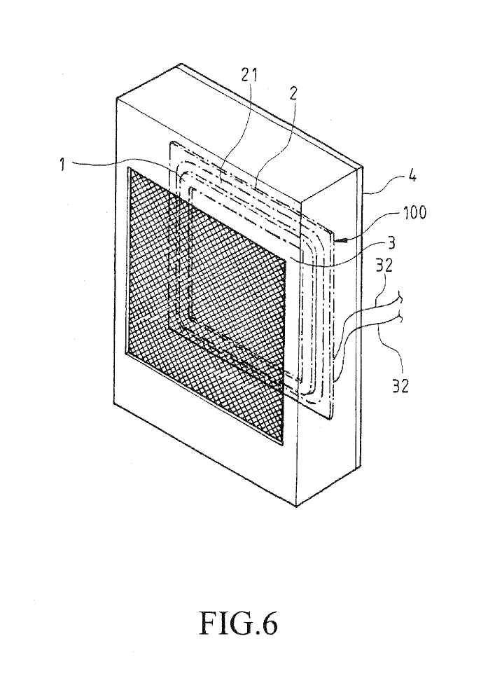

FIG. 6 is a view of an embodiment of the present invention. Referring to FIG. 6, the loudspeaker structure of the present invention can be applied to thinned products such as i-pad, i-phone or mobile phones, headphones, speaker boxes and notebook computers. Furthermore, the whole thin loudspeaker 100 can be fixed in a speaker box 4, and likewise, the lead wire 32 is connected to post-stage amplification circuits of different products (such as an amplifier or OP AMP). After the sound-making member 31 receives an audio signal, a sound is guided out through the upper drum paper 1 and the lower drum paper 2, and is emitted by the speaker box 4, thereby forming another aspect of the present invention.

Compared with a conventional thin loudspeaker, the present invention has at least the following advantages:

1. The loudspeaker of the present invention is further thinned, so that it can be used more widely.

2. The loudspeaker of the present invention makes sound by sandwiching the steel sheet 3 between the upper drum paper 1 and the lower drum paper 2, so that the medium frequency and the high frequency are not distorted, an approximate ultra-low frequency can be guided out at low frequency, which may reach 200 Hz, and the reproduction of the original sound achieves a better effect.

3. In the present invention, the upper drum paper 1 can compensate for sound dissipation of the lower drum paper 2, so that the overall sound effects are more stable. The lower drum paper 2 also has an excellent guiding effect at low frequency, which may reach 200 Hz, so the low frequency sound is not dissipated.

4. The frame-defining portion 21 disposed in the lower drum paper 2 can achieve a compensating effect at low frequency, and thus the whole thin loudspeaker can achieve a full-range sounding effect.

5. Without the magnets and voice coils of the conventional loudspeaker, the loudspeaker of the present invention conforms to the energy saving, power-saving and environmental protection requirements.

In summary, the present invention uses an upper drum paper, a lower drum paper, together with a steel sheet sandwiched between the upper drum paper and the lower drum paper to form an ultra-thin loudspeaker. After the sound-making member receives an audio signal, a sound is guided out through the upper drum paper and the lower drum paper. Therefore, the loudspeaker of the present invention is applied to thinned products such as i-pad, i-phone or mobile phones, headphones, speaker boxes and notebook computers, and is convenient to fabricate and assemble and produce better sound effects.

I claim:

1. An ultra-thin loudspeaker structure, comprising:
a lower drum paper provided with an opening at the center;
an upper drum paper smaller than the lower drum paper, and provided with an opening at the center;
a steel sheet sandwiched between the upper drum paper and the lower drum paper, and provided with a sound-making member stacked by a plurality of ceramic material layers;
wherein a thin loudspeaker is formed by the combination of the above members, and after the sound-making member receives an audio signal, a sound is guided out through the upper drum paper and the lower drum paper.

2. The ultra-thin loudspeaker structure of claim 1, wherein a winding semicircle-shaped protrusion is disposed in a position adjacent to an edge of the lower drum paper, and thus a protruding frame-defining portion is formed, and wherein the upper drum paper has an area approximately equal to that of an inner edge of the frame-defining portion, so that the upper drum paper is embedded in the inner edge of the frame-defining portion.

3. The ultra-thin loudspeaker structure of claim 1, wherein the upper drum paper and the lower drum paper are made of base paper, cloth, wood chip or foam, polyethylene terephthalate (PET), polyethylene naphthalate (PEN) and polyetherimide (PEI).
